(19) United States
(12) Patent Application Publication
(10) Pub. No.: US 2009/0079540 A1
(43) Pub. Date: Mar. 26, 2009

(54) ELECTRONIC SYSTEM OF MANAGEMENT OF MULTI-ADDRESS ACCESS

(76) Inventor: Evgeniy Aleksandrovich Grafeev, Omsk (RU)

Correspondence Address: YOUNG & THOMPSON, 209 Madison Street, Suite 500, ALEXANDRIA, VA, 22314, US

(21) Appl. No.: 12/097,558

(22) PCT Filed: Dec. 15, 2005
(86) PCT No.: PCT/RU2005/000646

§ 371 Date: Jun. 16, 2008

(51) Int. Cl. G06K 9/00; E05B 45/06; G08B 13/22

(52) U.S. Cl. 340/5.83; 340/542

(57) ABSTRACT

Intelligent access management system contains an electronic key executed for fingerprint identification of the user. The multi-address access management system contains an electronic key, an electronic lock, a storage device, an identification and processing unit. The electronic key includes a wafer and mounted on the wafer: a scanning device for obtaining the fingerprint data of the user's fingers and converting them into a digital format, a device for interfacing the electronic key with the electronic lock, a key management device, a device for display of information about the state of the key and the input information, a power supply unit, a storage device, and the electronic lock contains an access blocking device which is connected to the output of the identification and processing unit. The invention ensures using the key for diverse access management systems with reduced risk of unscrupulous use of the electronic key by an illicit user.

### TECHNICAL FIELD

The invention relates to intelligent access management systems which contain an electronic key executed with the possibility of fingerprint identification of the user, and can be used in any area in which protected access to financial, material and information resources is necessary.

### PRIOR ART

Access management means are used in the security systems of organizations and businesses, access monitoring systems in the banking sector in settlements for goods and services consumed, systems of management of access to information and software resources, devices for monitoring access to motor vehicles [patents RU No. 2208247, No. 2035067, No. 2106014].

Some of these means, when they are lost, can be illicitly used by outside parties. In addition, many devices in which protection from illicit access is ensured by use of digital or alphanumeric codes with a limited number of characters (and accordingly a limited number of combination variations) do not ensure the proper level of protection, since these codes can be easily cracked using special methods and means of technical surveillance, for example remote observation or electromagnetic monitoring.

These defects were partially remedied in a device disclosed in the specification for patent RU 2212708 published on Sep. 20, 2003, which contains an electronic key executed with the possibility of fingerprint identification of the user. This device can be adopted as a prototype of the suggested invention. It contains a key wafer, and mounted on it the following: a scanning device which ensures reception of the fingerprint data of the user's finger and their conversion into digital format, a storage device, an identification and processing unit connected to the storage device, a device for interfacing the electronic key with an electronic lock which is connected to the main computer, which device transmits to the main computer the user fingerprint identification code which was obtained in scanning, with a reference print stored in the storage device, and a key management device in the form of a set of function keys, a device for display of information about the state of the key and input information, and a power supply unit.

The disadvantage of this device is the inadequate degree of protection of the electronic key from the encroachments of unscrupulous outside parties.

### DISCLOSURE OF THE INVENTION

The object of this invention is to develop a universal electronic key which ensures the possibility of its use for several different systems of access management, with increased ease of obtaining access to various material, information and financial resources, which implements identification of the user by fingerprints, with a reduced risk of unscrupulous use of the electronic key by an illicit user in the case of its loss, misappropriation or other illegal action.

According to this invention, this object is achieved in that in the multi-address access management system which contains an electronic key, an electronic lock, a storage device, an identification and processing unit, the electronic key including a wafer and the following mounted on the wafer: a scanning device for obtaining the fingerprint data of the users fingers and converting them into a digital format, a device for interfacing the electronic key with the electronic lock, a key management device, a device for display of data about the state of the key and the input information, a power supply unit, a storage device, an identification and processing unit are mounted in the electronic lock the electronic lock additionally contains an access blocking device which is connected to the output of the identification and processing unit which upon a decision about the identification “illicit user” makes it impossible to further use the electronic key for a given protected resource, the scanning device is made with the possibility of obtaining the fingerprint data of at least two fingers of the user, the identification and processing unit is made with the possibility of making decisions according to delivered fingerprint data of at least two fingers of the user and their time sequence, the key management device contains the input device of the key use mode, which for a given protected resource ensures the electronic key initialization mode and the mode of its working use, and an additional memory unit for storing information for access to the electronic lock for each of the protected resources which are accessible to the electronic key, and is made with the possibility of supporting multi-address access to the electronic locks of various protected resources.

In a preferred version of its design the unit for processing and identification of the electronic lock has independent units for comparison of two or more user fingerprints and a circuit for determining the time sequence of delivery of signals of their images to this device.

In some design versions of the electronic management system its electronic key can additionally contain a signal encoding unit which is connected between the input of the electronic lock and the input of the storage device of the electronic lock, and a signal decoding unit which is connected between the output of the storage device of the electronic lock and the electronic lock processing and identification unit.

In some design versions of the electronic management system its electronic key can additionally contain a data encoding unit which is connected between the output of the scanning device and the input of the interface device of the electronic key with the electronic lock, and the electronic lock contains a data decoding unit which is connected between the input of the electronic lock and the electronic lock processing and identification unit.

In some design versions of the electronic management system its electronic key can additionally contain an electronic key storage device which is designed for storage of reference data of user fingerprint samples and the time sequence of their scanning, the electronic key processing and identification unit, which are made with the possibility of making decisions from the delivered data of the prints of at least two fingers of the user and their time sequence, and a key blocking device whose input is connected to the output of the electronic key processing and identification unit.

In addition, the output of the key blocking device can be connected to the interface device of the electronic key with the electronic lock.

In some design versions of the electronic management system its electronic lock can additionally contain an alarm notification device which is connected to the output of the identification and processing unit which is actuated for a decision about the identification “forcible access”, and the electronic key additionally contains a key blocking device which is connected to the interface device of the electronic key with the electronic lock, which upon a decision about identification “forcible access” makes further use of the electronic key impossible for the entire aggregate of protected resources which are accessible to the electronic key.

### DESCRIPTION OF THE DRAWINGS

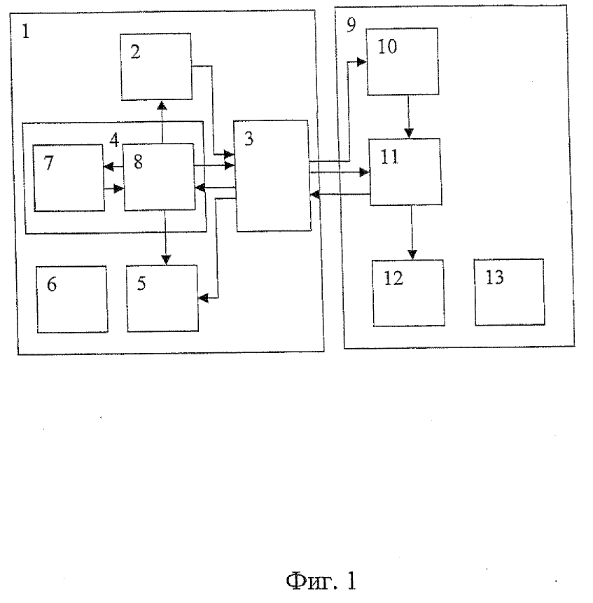

The invention is explained using FIGS. 1-7 which schematically show possible modifications of the electronic multi-address access management system.

The reference numbers of the units shown in FIGS. 1-7 are described below:

1—key wafer, 2—scanning device, 3—interface device of the key with the electronic lock, 4—key management device, 5—display device, 6—key power supply unit, 7—management device memory unit, 8—key use mode input unit, 9—electronic lock, 10—storage device, 11—identification and processing unit, 12—access blocking device, 13—lock power supply unit, 14—unit for comparison of the prints of one of the fingers, 15—unit for comparison of the prints of a second of the fingers, 16—circuit for determining the time sequence of signal delivery, 19—data encoding unit, 20—data decoding unit, 21—key storage device, 22—key identification and processing unit, 23—key blocking device, 24—alarm notification device.

The proposed electronic multi-address access management system (FIG. 1) contains an electronic key which includes a wafer 1, the following mounted on the wafer 1: a scanning device 2, an interface device 3 of the key to the electronic lock, a key management device 4 which includes the management device memory unit 7, a key use mode input unit 8, a display device 5, a key power supply unit 6, an electronic lock 9 which includes the storage device 10, an identification and processing unit 11, an access blocking device 12, and a lock power supply unit 13.

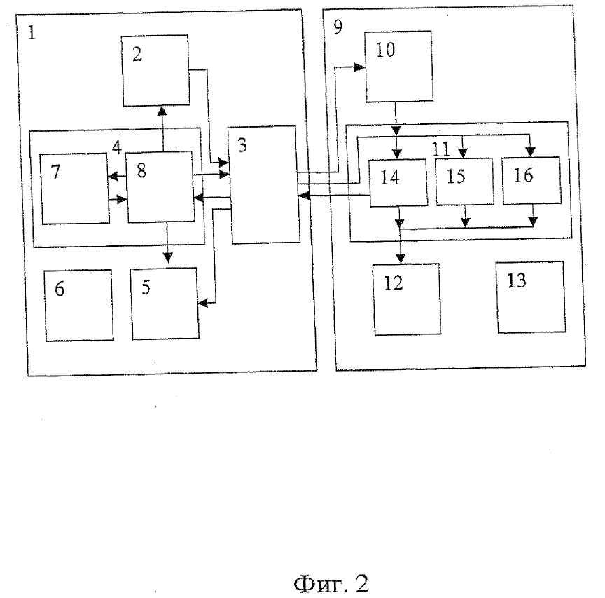

The proposed electronic multi-address access management system (FIG. 2) contains an electronic key which includes a wafer 1, the following mounted on the wafer 1: a scanning device 2, an interface device 3 of the key to the electronic lock, a key management device 4 which includes the management device memory unit 7, a key use mode input unit 8, a display device 5, a key power supply unit 6, an electronic lock 9 which includes the storage device 10, an identification and processing unit 11, an access blocking device 12, a lock power supply unit 13, a unit for comparison of the prints of one of the fingers 14, a unit for comparison of the prints of a second of the fingers 15, and a circuit for determining the time sequence of signal delivery 16.

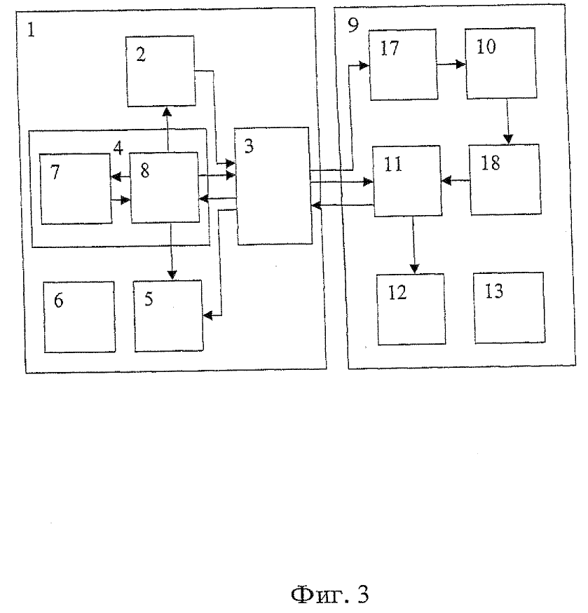

The proposed electronic multi-address access management system (FIG. 3) contains an electronic key which includes a wafer 1, the following mounted on the wafer 1: a scanning device 2, an interface device 3 of the key to the electronic lock, a key management device 4 which includes the management device memory unit 7, a key use mode input unit 8, a display device 5, a key power supply unit 6, an electronic lock 9 which includes the storage device 10, an identification and processing unit 11, an access blocking device 12, a lock power supply unit 13, a signal encoding unit 17, a signal decoding unit 18.

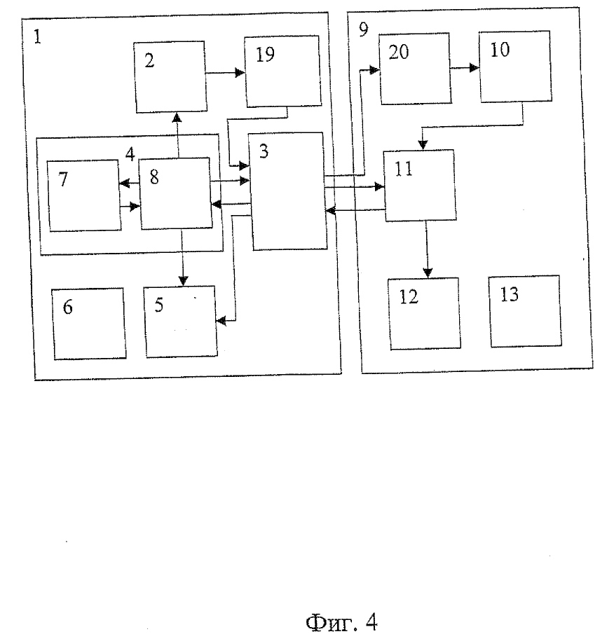

The proposed electronic multi-address access management system (FIG. 4) contains an electronic key which includes a wafer 1, the following mounted on the wafer 1: a scanning device 2, an interface device 3 of the key to the electronic lock, a key management device 4 which includes the management device memory unit 7, a key use mode input unit 8, a display device 5, a key power supply unit 6, an electronic lock 9 which includes the storage device 10, an identification and processing unit 11, an access blocking device 12, a lock power supply unit 13, a data encoding unit 19, and a data decoding unit 20.

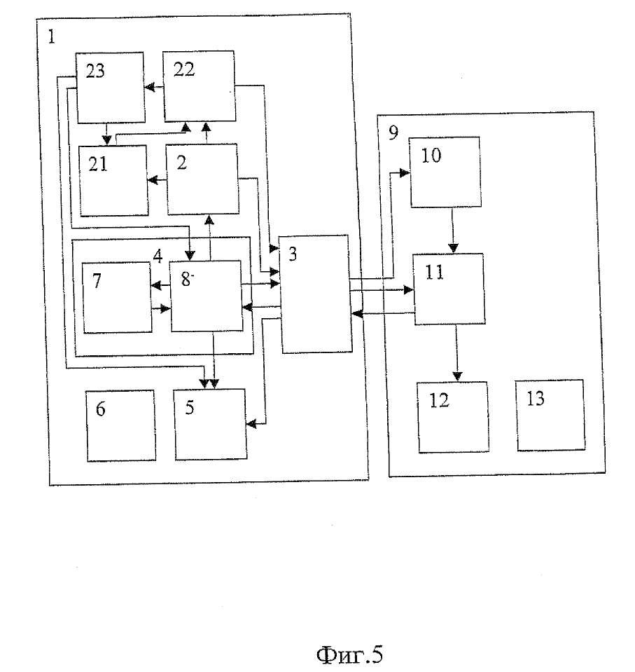

The proposed electronic multi-address access management system (FIG. 5) contains an electronic key which includes a wafer 1, the following mounted on the wafer 1: a scanning device 2, an interface device 3 of the key to the electronic lock, a key management device 4 which includes the management device memory unit 7, a key use mode input unit 8, a display device 5, a key power supply unit 6, an electronic lock 9 which includes the storage device 10, an identification and processing unit 11, an access blocking device 12, a lock power supply unit 13, a key storage device 21, a key identification and processing unit 22, and a key blocking device 23.

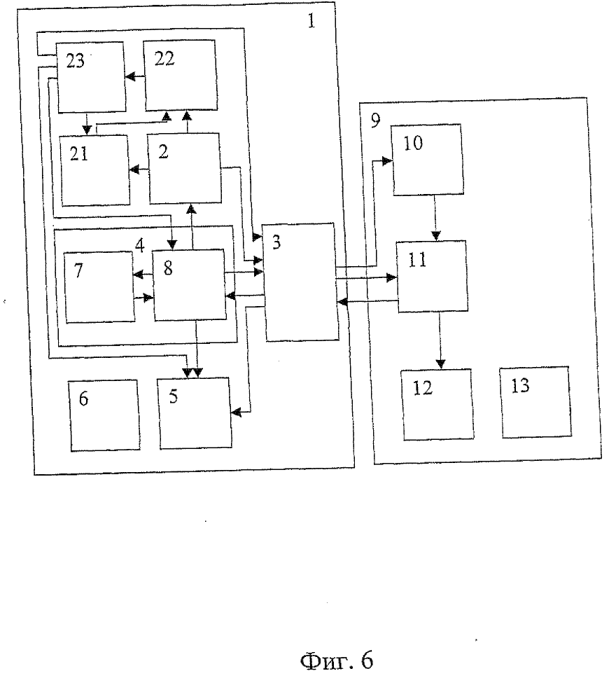

The proposed electronic multi-address access management system (FIG. 6) contains an electronic key which includes a wafer 1, the following mounted on the wafer 1: a scanning device 2, an interface device 3 of the key to the electronic lock, a key management device 4 which includes the management device memory unit 7, a key use mode input unit 8, a display device 5, a key power supply unit 6, an electronic lock 9 which includes the storage device 10, an identification and processing unit 11, an access blocking device 12, a lock power supply unit 13, a key storage device 21, a key identification and processing unit 22, and a key blocking device 23.

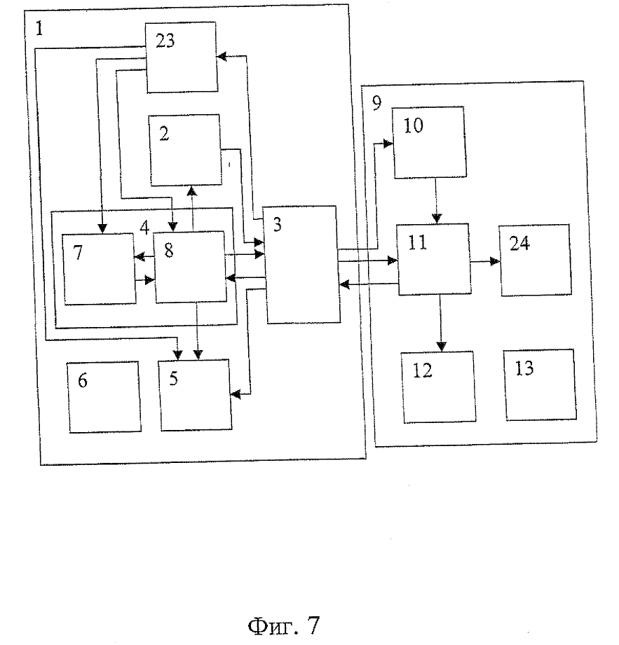

The proposed electronic multi-address access management system (FIG. 7) contains an electronic key which includes a wafer 1, the following mounted on the wafer 1: a scanning device 2, an interface device 3 of the key to the electronic lock, a key management device 4 which includes the management device memory unit 7, a key use mode input unit 8, a display device 5, a key power supply unit 6, an electronic lock 9 which includes the storage device 10, an identification and processing unit 11, an access blocking device 12, a lock power supply unit 13, an alarm notification device 24, and a key blocking device 23.

### Principle of Realization of the Invention

The proposed electronic multi-address access management system works as follows.

The use of the electronic key to obtain access to a specific protected resource presupposes its preliminary initialization (registration) in the corresponding electronic lock. The electronic key is initialized as follows. Using the management device 4 the user connects the electronic key, establishes the initialization mode, specifies the type of the electronic lock/protected resource (for example ATM, work station, computer with access to an electronic bank to protected Internet resources etc., house or apartment, motor vehicle) and shapes the signal to start scanning. Then, on the scanning device 2 the user registers the pads of two or more fingers in a sequence determined by him for scanning their prints, afterwards he shapes the signal to end scanning (registration of a sample of input fingerprints for a given time delay after the last fingerprint input by the user is possible). Information about the aggregate of fingerprints and the sequence of their scanning which was obtained as a result of scanning is transmitted via the interface device 3 of the electronic key with the electronic lock to the storage device 10 of the electronic lock 9 where it is registered with attachment to the individual information of the user of a given resource (FIO, address, digital key no., user status, etc.); here the electronic lock delivers to the electronic key information which ensures subsequent attachment of a given electronic key to the database of the electronic lock (including, if necessary, searching for the corresponding data of the lock in a worldwide database) and “initialization completed” signal.

In the case of unsuccessful scanning of the user's fingerprints a “repeat scanning” signal is sent from the electronic lock 9 to the digital key, in doing so the corresponding information is displayed on the key display device 5.

Information about completion of initialization of the electronic key 1 in the electronic lock 9 is displayed by the display device 5.

Use of the electronic key in the working mode proceeds as follows. Using the key management device 4 the electronic key is connected, the “use” mode is established, the specific protected resource to which access is intended is set, and the signal to start scanning is shaped. Then the user registers on the scanning device 2 the pads of his fingers in a sequence determined by him for scanning their prints, afterwards he shapes the signal to end scanning (registration of a sample of input fingerprints for a given time delay after the last fingerprint which has been input by the user is possible).

Information about the aggregate of fingerprints, including the fingerprint traits of the user's fingers, and the time sequence of their scanning, which was obtained as a result of scanning, is transmitted via the interface device of the electronic key with the electronic lock to the electronic lock identification and processing unit 1, where comparison of the user's fingerprints and the time sequence of their scanning to the data which have been stored in the electronic lock storage device 10 and which are registered when the electronic key is initialized (user identification).

With positive identification of the user by the identification and processing unit 11 the criterion “legitimate user” is formed and is sent to the access blocking device 12 and via the interface device 3 of the electronic key with the electric lock, to the electronic key where it is displayed by the display device 5. In doing so, access to resources according to the user status is opened to the given electronic key.

For an insufficient level of probability of correct identification (due for example to poor quality of the completed user fingerprint scanning) the electronic lock identification and processing unit 11 forms the criterion “additional scanning” which is sent via the interface device 3 of the electronic key with the electric lock to the key management device 4 and display unit 5. In this case the user for identification should repeat the scanning procedure. The number of repeated scanning attempts is limited to a given number.

For negative identification of the user by the identification and processing unit 11 the criterion “illicit user” is formed.

The decision about identification “illicit user” which makes impossible further use of the electronic key for a given type of protected resources is made for negative identification of the user according to some of the monitored criteria, for example when an incorrect sequence of fingerprint scanning is ascertained, one of the fingerprints does not match, etc. or attempts at repeated scanning according to the previous item are exhausted.

The criterion “illicit user” which is formed by the identification and processing unit 11 is sent to the access blocking device 12 which blocks the electronic key and access from it to a given electronic lock/protected resource for a certain time interval (for example an hour, 24 hours, etc.). For repeated generation of the criterion “illicit user” for a given electronic key (which is done for a repeated attempt to identify the user after the time interval of blocking of a given electronic key has expired), the access blocking device 12 finally blocks a given electronic key and access from it to a given electronic lock/protected resource.

For comparison of the prints of two fingers of the user with allowance for the time sequence of delivery of the signals of these prints to the key identification and processing unit 11 the interconnected independent unit 14 for comparison of the prints of one of the fingers, the unit 15 for comparison of the prints of the second of the fingers, and circuits 16 for determining the time sequence of signal delivery can be connected in sequence (FIG. 2).

Reference information about the fingerprints of a legitimate user when the key is initialized is sent for storage in the storage device 10 of the electronic lock 9 via the signal coding unit 17 (FIG. 3), in doing so, to carry out identification of the user in the working mode the reference information is sent to the identification and processing unit 11 via the signal decoding unit 18.

Information about the user fingerprints from the scanning device 2 can be transmitted to the interface device 3 of the electronic key with the electronic lock via the fingerprint information coding unit 19 (FIG. 4) and when sent to the electrical lock 9 prior to transmission to the storage device 10 (when the key is initialized) and to the identification and processing unit 11 (in the working mode) it can be sent beforehand to the fingerprint information decoding unit 20.

The operation of the proposed multi-address access management system executed in accordance with the diagram which corresponds to FIG. 5 differs in that the information about the aggregate of fingerprints, including fingerprint traits of the user's fingers, and the time sequence of their scanning, which was obtained as a result of scanning, is sent to the key identification and processing unit 22 where comparison of the fingerprints of the user and the time sequence of their scanning to the data which have been stored in the key storage device 21 and which are registered when the electronic key is initialized is done.

For negative identification of the user, the key blocking device 23 blocks access of the electronic key to the electronic lock 9. The corresponding information is transmitted to the device 5 for display.

For positive identification of the user by the key identification and processing unit 22 the criterion “access to second stage opened” is formed and sent to the display device 5 and via the interface device 3 of the electronic key with the electric lock to the electronic lock 9. In doing so, the information of completed scanning about the aggregate of fingerprints, including the fingerprint traits of the user's fingers, and the time sequence of their scanning is also sent to the electronic lock 9 via the interface device 3, where it is compared to the reference information stored in the storage device 10 of the electronic lock in the electronic lock identification and processing unit 11.

For positive identification of the user by the electronic lock 9 identification and processing unit 11 the user acquires access to resources according to his status.

For negative identification of the user, the electronic key and access from it to a given electronic lock/protected resource are blocked according to the general operating scheme of the system (FIG. 1).

The suggested multi-address access management system (FIG. 6) which additionally contains a key blocking device 23 additionally delivers to the electronic lock 9 information about negative identification of the user for blocking of a given electronic key by the electronic lock.

In the proposed system (FIG. 7), in the identification and processing unit 11 there is the additional possibility of ascertaining a situation of forcible access to the protected resource with generation of the “forcible access” criterion in this case.

The decision about identification “forcible access” which makes it impossible to further use the electronic key for the entire aggregate of protected resources accessible to the electronic key, with downloading of the alarm notification device of the electric lock is made when the electronic lock identification and processing unit in the composition of the information having been sent from the electronic key ascertains certain data coded as criteria of forcible access. These data (their composition is determined by a legitimate user from the established list and is registered when the key is initialized) can be for example the presence, in the data which have been sent from the electronic key, of results of scanning of the print of a certain finger of the user which indicates this situation, lack of agreement with data of a reference scan for all delivered fingerprints, etc. Operation of the “forcible access” system is established at the request of the user when the key is initialized.

The criterion “forcible access” which is formed by the identification and processing unit 11 is sent to the access blocking device 12 which blocks the electronic key and access from it to a given electronic lock/protected resource, to the alarm notification device 24 of the electronic lock which delivers a certain signal to the corresponding security service, and also via the interface device 3 to the key blocking device 23. The latter upon reception of the “forcible access” criterion blocks further use of the electronic key for the entire aggregate of protected resources accessible to it.

For practical implementation of the proposed electronic key, standard electronic parts can be used, the requirements for which do not exceed the capabilities of modem microcircuit engineering. Almost all the assemblies of the device are standard and are widely used in modern hardware.

The electronic multi-address access management system suggested in this invention has the following advantages.

1. The electronic universal access device is a universal means of access to different types of resources (for example, ATM, work station, computer with access to an electronic bank, protected Internet resources etc., house or apartment, motor vehicle), therefore it is sufficient for the user to have one electronic key for obtaining access to different protection systems.

2. When using an electronic universal access device to access monitored resources, the decision whether the holder of the electronic key is a legitimate user is made based on a comparison of the data of scanning of the prints of two and more fingers of the key holder in a certain sequence which are obtained from the scanning device with data of reference scanning of the fingerprints (sample of scanning of the fingerprints of a legitimate user formed when the electronic key is initialized) which are stored in the memory of the electronic lock; this greatly increases the level of protection of the system from an attempt at unscrupulous access and makes it possible to significant reduce the risk of unscrupulous use of the electronic key by an illicit user in the case of its loss or theft.

3. When using this access management system the risk of an outside party unscrupulously obtaining information for access to the protected resources in the process of transmitting scanning data via the interface device of the electronic key with the electronic lock is reduced due to use of encoding of the information being transmitted.

4. When using this access management system the risk of an outside party unscrupulously obtaining information for access to the protected resources from the database of the electronic lock is reduced due to encoding of the information stored in it.

5. When using this access management system the user is protected from an attempt at forcible access to the protected resources due to the hardware and software of the system which ensure that this situation is detected according to criteria coordinated beforehand with a legitimate user and which guarantee blocking of the electronic key for all types of resources accessible to it with delivery of a signal to the alarm notification device of the electronic key.

6. When a digital key is lost the user can use a new digital key for access by first initializing it.

1. Electronic multi-address access management system which contains an electronic key, an electronic lock, a storage device, an identification and processing unit, the electronic key including a wafer and the following mounted on the wafer: a scanning device for obtaining the fingerprint data of the user's fingers and converting them into a digital format, a device for interfacing the electronic key with the electronic lock, a key management device, a device for display of information about the state of the key and the input information, a power supply unit, characterized in that the storage device, the identification and processing unit are mounted in the electronic lock, the electronic lock additionally contains an access blocking device which is connected to the output of the identification and processing unit which upon a decision about the identification “illicit user” makes further use of the electronic key impossible for a given protected resource, the scanning device is made with the possibility of obtaining the fingerprint data of at least two fingers of the user, the identification and processing unit is made with the possibility of making decisions according to delivered fingerprint data of at least two fingers of the user and their time sequence, the key management device contains the input device of the key use mode, which for a given protected resource ensures the electronic key initialization mode and the mode of its working use, and an additional memory unit for storing information for access to the electronic lock for each of the protected resources which are accessible to the electronic key, and is made with the possibility of supporting multi-address access to the electronic locks of various protected resources.

2. System as claimed in claim 1, wherein the unit for processing and identification of the electronic lock has independent units for comparison of two or more user fingerprints and a circuit for determining the time sequence of delivery of signals of their images to this device.

3. System as claimed in claim 1, wherein the electronic lock additionally contains a signal encoding unit which is connected between the input of the electronic lock and the input of the storage device of the electronic lock, and a signal decoding unit which is connected between the output of the storage device of the electronic lock and the electronic lock processing and identification unit.

4. System as claimed in claim 1, wherein the electronic key additionally contains a data encoding unit which is connected between the output of the scanning device and the input of the interface device of the electronic key with the electronic lock, and the electronic lock contains a data decoding unit which is connected between the input of the electronic lock and the electronic lock processing and identification unit.

5. System as claimed in claim 1, wherein the electronic key additionally contains an electronic key storage device which is designed for storage of reference data of user fingerprint samples and the time sequence of their scanning, the electronic key processing and identification unit, which are made with the possibility of making decisions from the delivered data of the prints of at least two fingers of the user and their time sequence, and a key blocking device whose input is connected to the output of the electronic key processing and identification unit.

6. System as claimed in claim 5, wherein the output of the key blocking device is connected to the interface device of the electronic key with the electronic lock.

7. System as claimed in claim 1, wherein the electronic lock additionally contains an alarm notification device which is connected to the output of the identification and processing unit which is actuated for a decision about identification “forcible access”, and the electronic key additionally contains a key blocking device which is connected to the interface device of the electronic key with the electronic lock, which upon a decision about identification “forcible access” makes further use of the electronic key impossible for the entire aggregate of protected resources which are accessible to the electronic key.
